(19) United States
(12) Patent Application Publication
(10) Pub. No.: US 2012/0084329 A1
(43) Pub. Date: Apr. 5, 2012

(54) MOVING LARGE VOLUMES OF DATA FROM FACT TO ARCHIVE TABLES

(75) Inventors: Akshaya Arora, Bothell, WA (US); Dana Pepper, Federal Way, WA (US); Giri Sundaram, Issawuah, WA (US)

(73) Assignee: Microsoft Corporation, Redmond, WA (US)

(21) Appl. No.: 12/896,915

(22) Filed: Oct. 4, 2010

(51) Int. Cl. G06F 17/30

(52) U.S. Cl. 707/809; 707/E17.005

(57) ABSTRACT

The claimed subject matter provides a system and/or a method for moving large volumes of data. An exemplary method comprises receiving a request to transfer a plurality of rows from a first table to a second table. The first table may be determined to be associated with a same file group as the second table. The plurality of rows may be moved from the first table to the second table by transferring a partition for the first table to the second table.

Systems that process large volumes of data, such as search engine websites, are typically constrained by response times for their clients. As such, it is useful to organize these large volumes to facilitate accesses that meet these constraints.

In some systems, the large volumes of data may be categorized according to a degree to which the data is recent or current. For example, data within the past hour/day/week/month/year may be considered current. In some estimates, current data may constitute up to 80% of the total data. Because the great majority of requests for data may be for current data, these systems may prioritize access to current data over older data. Prioritizing access may facilitate meeting the response time constraints.

In many systems, a database may be used to organize data in this way. For example, current data may be stored in fact tables, while older data may be stored in archive tables. In such a database, specific processes may be used to move data between fact and archive tables. However, some systems may include data covering years. As such, moving data in tables with such large volumes may be computationally expensive, impinging upon the response time constraints.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to a method and a system for moving large volumes of data between fact and archive tables. A request to move the data may be received. A database may determine that the fact and the archive tables belong to the same file group. The data may be moved by transferring a partition containing the data from the fact/archive table to the other.

In one exemplary embodiment, a sliding window current data may be kept within the fact tables. All data that falls out of the sliding window may be moved from fact to archive tables.

The method operates by storing the data within file groups on a storage area network. The file groups may include fact and archive tables. Each of the file groups may include data that is stored on numerous logical unit numbers.

An exemplary system moves large volumes of data between fact and archive tables.

Another exemplary embodiment of the subject innovation provides a non-transitory computer-readable medium that includes code to direct the operation of a processing unit. The code may direct the processing unit to move large volumes of data between fact and archive tables by transferring a partition containing the data from the fact/archive table to the other.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an enterprise storage system wherein aspects of the claimed subject matter can be employed;

FIG. 2 is a block diagram of a storage area network wherein aspects of the claimed subject matter can be employed;

FIG. 3 is a process flow diagram of a method for moving large volumes of data in accordance with the claimed subject matter;

FIG. 4 is a block diagram of an exemplary networking environment wherein aspects of the claimed subject matter can be employed; and

FIG. 5 is a block diagram of an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “engine,” “manipulator” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media. Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

The subject innovation relates to a method and a system for moving large volumes of data from fact to archive tables. The fact and archive tables may contain searchable data for a large volume system, such as a search engine site.

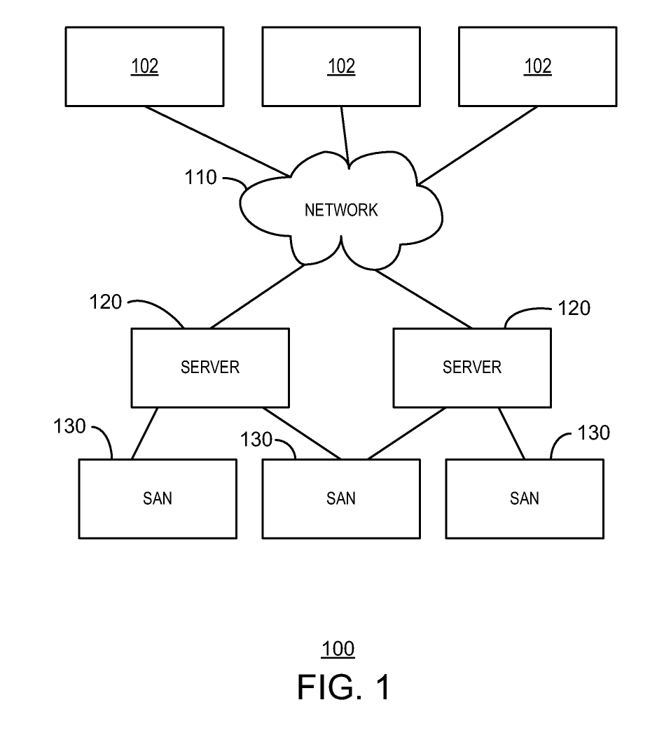

FIG. 1 is a block diagram of an enterprise storage system 100, wherein aspects of the claimed subject matter can be employed. However, the techniques are not limited to this configuration for the enterprise storage system 100, as any number of configurations can be used. For example, a large enterprise storage system 100 may often have many more servers 120 and SANs 130 than shown in this illustration.

In the enterprise storage system 100, servers 120 may provide data, such as Web pages, to one or more client computers 102 over a network 110. The network 110 may be a local area network (LAN), wide area network (WAN), a storage area network (SAN), or other network, such as the Internet.

The servers 120 may access the data for the clients 102 from storage area networks (SANs) 130. The SANs 120 may represent architectures that connect remote computer storage devices, such that the remote computer storage devices appear as locally attached to the servers 120.

The SANs 130 may store large volumes of data in databases. Current data may be stored in fact tables. Older data may be stored in archive tables. In one embodiment of the invention, a sliding window may be used to move data from between fact and archive tables. In other words, the system 100 may keep one year's worth of data in the fact tables: e.g., a one year window of daily data. Every day, the window slides another day, such that the last day drops out of the window, i.e., the data moves from the fact table to the archive table.

Typically, moving even a row of a very large table is computationally expensive. However, in an embodiment of the invention, large numbers of rows may be moved between fact and archive tables relatively cheaply. In comparison to the long amount of time that some systems may take to move a row of data in a very large table, embodiments of the invention may move a terabyte of data in

In such an embodiment, the fact tables and the archive tables may contain the same structure. In other words, the columns, indices, and partition definitions may be the same for a fact table and a corresponding archive table.

The partitions may define subsets of the fact/archive table data. As the data on a partition ages out of the sliding window, the partition may be re-assigned from the fact table to the archive table. The reverse may also be true. As such, large volumes of data may be moved between a fact table and an archive table by re-assigning the partition from one table to the other.

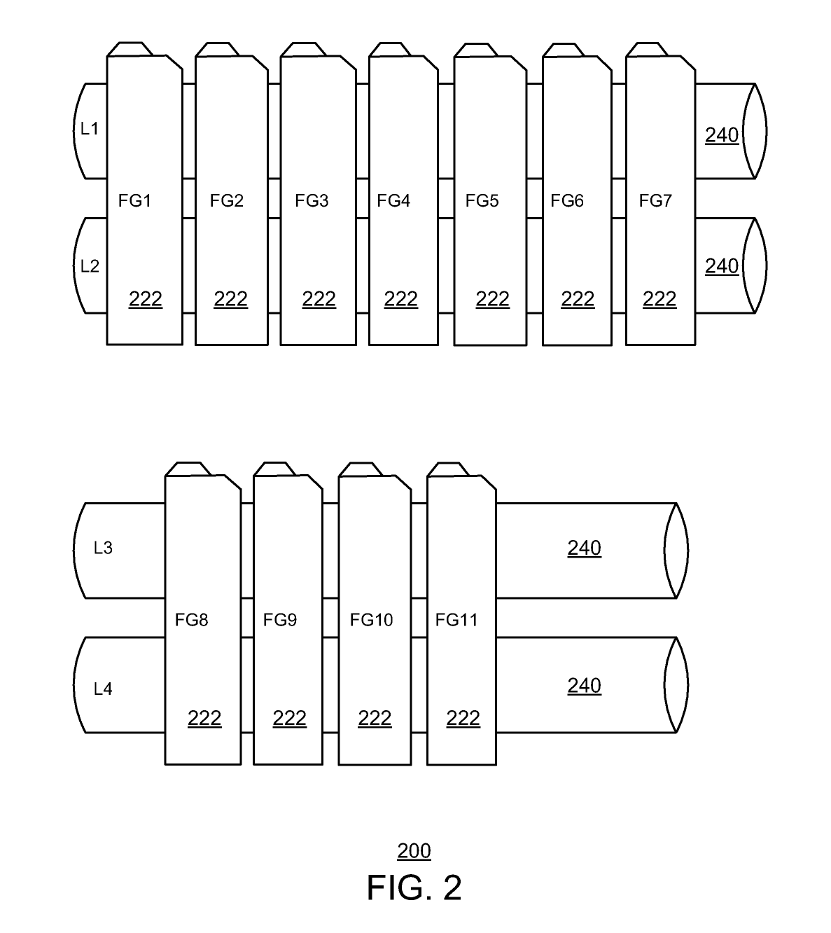

As understood by one skilled in the art, database tables and their partitions are stored in files on the SAN 130. FIG. 2 is a block diagram of the SAN 130 wherein aspects of the claimed subject matter can be employed. The SAN 130 may be a collection of numerous storage devices, e.g., logical units (LUNs) 240, e.g., L1-L4. The database table files may be stored on the LUNs 240, and arranged within file groups 222, e.g., FG1-FG11.

As shown, each file group 222 may include files that are stored on multiple LUNs 240. Generally speaking, as data ages, the SAN 130 may move older files, e.g., archive table files, to facilitate performance. Even though file is moved to different hardware, the archive table file may remain within the file group 222. As such, the files within the file group, e.g., FG1 may be stored on both L1 and L2. Additionally, the files for archive and fact tables may be distributed across each file group 222.

The file groups 222 may be organizations of data stored on the SAN 130. As understood by one skilled in the art, the file groups 222 may vary according to implementations, and may be topical, chronological, etc.

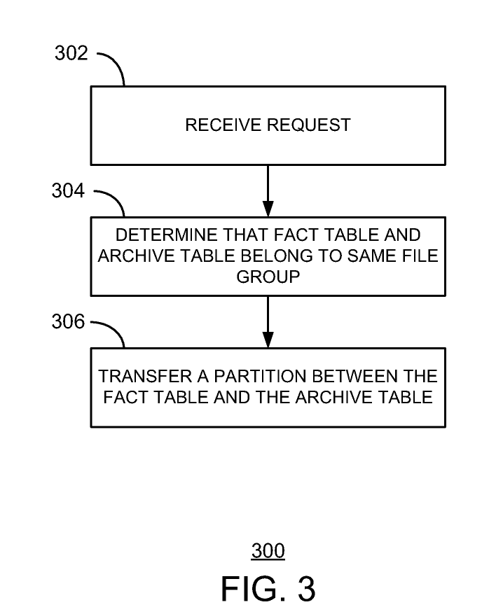

FIG. 3 is a process flow diagram of a method for moving large volumes of data. The method 300 starts at block 302, where a request to move a large volume of data may be received. The request may be a structured query language (SQL) statement as received by a database optimizer, or as a query plan executed by a database execution engine. The request may specify a source table and a destination table for the data to be moved, e.g., fact and archive tables. The request may also specify a partition containing the data to be moved.

At block 304, it may be determined that the fact table and the archive table belong to the same file group 222. Because the fact table and the archive table belong to the same file group 222, at block 306, the specified partition may be transferred from the fact table to the archive table.

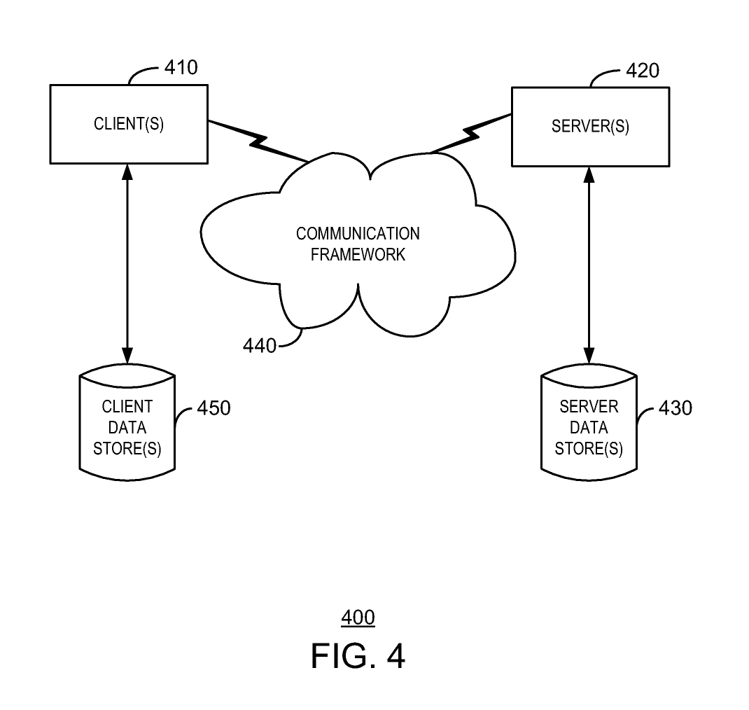

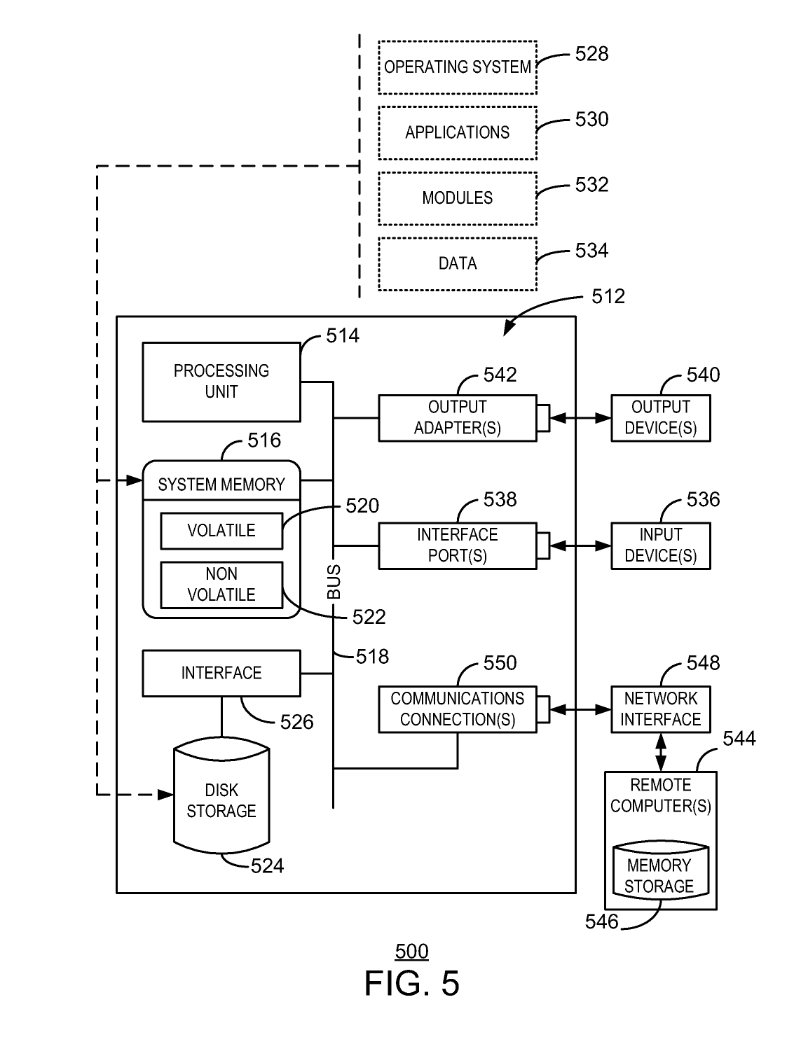

In order to provide additional context for implementing various aspects of the claimed subject matter, FIGS. 4-5 and the following discussion are intended to provide a brief, general description of a suitable computing environment in which the various aspects of the subject innovation may be implemented. For example, a content filter, as described in the previous figure, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the subject innovation may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 4 is a schematic block diagram of a sample-computing system 400 with which the claimed subject matter can interact. The system 400 includes one or more client(s) 410. The client(s) 410 can be hardware and/or software (e.g., threads, processes, computing devices). The system 400 also includes one or more server(s) 420. The server(s) 420 can be hardware and/or software (e.g., threads, processes, computing devices). The servers 420 can house threads to perform search operations by employing the subject innovation, for example.

One possible communication between a client 410 and a server 420 can be in the form of a data packet adapted to be transmitted between two or more computer processes. The system 400 includes a communication framework 440 that can be employed to facilitate communications between the client(s) 410 and the server(s) 420. The client(s) 410 are operably connected to one or more client data store(s) 450 that can be employed to store information local to the client(s) 410. The client data store(s) 450 do not have to be in the client(s) 410, but may be located remotely, such as in a cloud server. Similarly, the server(s) 420 are operably connected to one or more server data store(s) 430 that can be employed to store information local to the servers 420.

As an example, the client(s) 410 may be computers providing access to social search engine sites over a communication framework 440, such as the Internet. The server(s) 420 may be search engine sites accessed by the client.

With reference to FIG. 5, an exemplary environment 500 for implementing various aspects of the claimed subject matter includes a computer 512. The computer 512 includes a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514.

The system bus 518 can be any of several types of bus structure(s) including the memory bus or memory controller, a peripheral bus or external bus, and/or a local bus using any variety of available bus architectures known to those of ordinary skill in the art.

The system memory 516 is non-transitory computer-readable media that includes volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), or flash memory.

Volatile memory 520 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 512 also includes other non-transitory computer-readable media, such as removable/non-removable, volatile/non-volatile computer storage media. FIG. 5 shows, for example a disk storage 524. Disk storage 524 includes, but is not limited to, devices like a magnetic disk drive, floppy disk drive, tape drive, Jaz drive, Zip drive, LS-100 drive, flash memory card, or memory stick.

In addition, disk storage 524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 524 to the system bus 518, a removable or non-removable interface is typically used such as interface 526.

It is to be appreciated that FIG. 5 describes software that acts as an intermediary between users and the basic computer resources described in the suitable operating environment 500. Such software includes an operating system 528. Operating system 528, which can be stored on disk storage 524, acts to control and allocate resources of the computer system 512.

System applications 530 take advantage of the management of resources by operating system 528 through program modules 532 and program data 534 stored either in system memory 516 or on disk storage 524. It is to be appreciated that the claimed subject matter can be implemented with various operating systems or combinations of operating systems.

A user enters commands or information into the computer 512 through input device(s) 536. Input devices 536 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 536 connect to the processing unit 514 through the system bus 518 via interface port(s) 538. Interface port(s) 538 include, for example, a serial port, a parallel port, a game port, and a universal serial bus (USB).

Output device(s) 540 use some of the same type of ports as input device(s) 536. Thus, for example, a USB port may be used to provide input to the computer 512, and to output information from computer 512 to an output device 540.

Output adapter 542 is provided to illustrate that there are some output devices 540 like monitors, speakers, and printers, among other output devices 540, which are accessible via adapters. The output adapters 542 include, by way of illustration and not limitation, video and sound cards that provide a means of connection between the output device 540 and the system bus 518. It can be noted that other devices and/or systems of devices provide both input and output capabilities such as remote computer(s) 544.

The computer 512 can be a server hosting a search engine site in a networked environment using logical connections to one or more remote computers, such as remote computer(s) 544. The remote computer(s) 544 may be client systems configured with web browsers, PC applications, mobile phone applications, and the like, to allow users to access the social networking site, as discussed herein. The remote computer(s) 544 can be a personal computer, a server, a router, a network PC, a workstation, a microprocessor based appliance, a mobile phone, a peer device or other common network node and the like, and typically includes many or all of the elements described relative to the computer 512. For purposes of brevity, only a memory storage device 546 is illustrated with remote computer(s) 544. Remote computer(s) 544 is logically connected to the computer 512 through a network interface 548 and then physically connected via a communication connection 550.

Network interface 548 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 550 refers to the hardware/software employed to connect the network interface 548 to the bus 518. While communication connection 550 is shown for illustrative clarity inside computer 512, it can also be external to the computer 512. The hardware/software for connection to the network interface 548 may include, for exemplary purposes only, internal and external technologies such as, mobile phone switches, modems including regular telephone grade modems, cable modems and DSL modems, ISDN adapters, and Ethernet cards.

An exemplary embodiment of the computer 512 may comprise a server hosting a search engine site. An exemplary processing unit 514 for the server may be a computing cluster comprising Intel® Xeon CPUs. The disk storage 524 may comprise an enterprise data storage system, for example, holding thousands of user pages. Exemplary embodiments of the subject innovation may move large volumes of data between fact and archive tables in a database. The subject innovation may move large volumes of data without impinging on the response-time constraints of the search engine site.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for moving large volumes of data, comprising:
receiving a request to move a plurality of rows from a first table to a second table;
determining that the first table is associated with a same file group as the second table; and
moving the plurality of rows from the first table to the second table by transferring a partition for the first table to the second table.

2. The method of claim 1, wherein the first table and the second table comprise:
a fact table;
an archive table; or
combinations thereof.

3. The method of claim 1, wherein the partition comprises the plurality of rows.

4. The method of claim 1, comprising determining that the plurality of rows is not within a sliding window of current data.

5. The method of claim 1, wherein a storage area network comprises:
the file group; and
a plurality of logical unit numbers.

6. The method recited in claim 5, wherein the file group comprises files stored on:
a first logical unit number; and
a second logical unit number.

7. The method of claim 1, wherein the request comprises a query plan specifying the first table, the second table, and the plurality of rows.

8. A system for decreasing duplicate entries on a server, comprising:
a processing unit; and
a system memory, wherein the system memory comprises code configured to direct the processing unit to:
receive a request to move a plurality of rows from a first table to a second table;
determine that the first table is associated with a same file group as the second table; and
move the plurality of rows from the first table to the second table by transferring a partition for the first table to the second table.

9. The system of claim 8, wherein the first table and the second table comprise:
a fact table;
an archive table; or
combinations thereof.

10. The system of claim 8, wherein the partition comprises the plurality of rows.

11. The system of claim 8, wherein the system memory comprises code configured to direct the processing unit to determine that the plurality of rows is not within a sliding window of current data.

12. The system of claim 8, wherein a storage area network comprises:
the file group; and
a plurality of logical unit numbers.

13. The system of claim 12, wherein the file group comprises files stored on:
a first logical unit number; and
a second logical unit number.

14. The system of claim 8, wherein the request comprises a query plan specifying the first table, the second table, and the plurality of rows.

15. A non-transitory, computer-readable medium, comprising code configured to direct a processing unit to:
receive a request to move a plurality of rows from a first table to a second table;
determine that the first table is associated with a same file group as the second table; and
move the plurality of rows from the first table to the second table by transferring a partition for the first table to the second table.

16. The non-transitory, computer-readable medium of claim 15, wherein the first table and the second table comprise:
a fact table;
an archive table; or
combinations thereof.

17. The non-transitory, computer-readable medium of claim 15, wherein the partition comprises the plurality of rows.

18. The non-transitory, computer-readable medium of claim 15, comprising code configured to direct the processing unit to determine that the plurality of rows is not within a sliding window of current data.

19. The non-transitory, computer-readable medium of claim 15, wherein a storage area network comprises:
the file group; and
a plurality of logical unit numbers.

20. The non-transitory, computer-readable medium of claim 15, wherein the file group comprises files stored on:
a first logical unit number; and
a second logical unit number.
